(19) United States
(12) Patent Application Publication
(10) Pub. No.: US 2013/0109511 A1
(43) Pub. Date: May 2, 2013

(54) NOVEL ENHANCED SYSTEMS, PROCESSES, METHODS AND APPARATUS FOR TRAINING HIGH-SKILL ATHLETES

(71) Applicant: Yevgeniy Galyuk, Van Nuys, CA (US)

(72) Inventor: Yevgeniy Galyuk, Van Nuys, CA (US)

(21) Appl. No.: 13/285,216

(22) Filed: Oct. 31, 2011

(51) Int. Cl. A63B 69/00; G09B 19/00

(52) U.S. Cl. 473/446; 434/247

(57) ABSTRACT

Training methods for elite athletes feature spheroid training tools with increasing numbers of faceted surfaces to deflect in alinear, quasi-randomized fashion from a flat surface when impacting the same under force of a user's throw. Kits, spheroid training tools, and advanced exercise regimens are likewise taught, along with internet based do-it-yourself instructions to create quasi-customized spheroid training tools.

### BACKGROUND OF THE INVENTIONS

The present inventions relate to training systems and apparatus. In specific, the present inventions teach those charged with tending goal new conditioning and coordination exercises and likewise offer for consideration devices to facilitate and enable the same.

The lead story in the Wall Street Journal's SPORTS section on Oct. 20, 2011 was entitled, “Have Goalies Become too Dominant?” Said story detailed how goaltenders (“goalies”) in ice hockey have evolved into the most effective and important aspect of defense in hockey. The present invention speaks to longstanding needs to develop high-skill aptitudes over time, for goalies in numerous sports, and those needing to address fitness along with training in hand-eye coordination and conditioning. However, artisans shall readily appreciate and understand applicability of the instant teaching to anyone wishing to develop or hone muscle memory needed to block and catch objects traveling at rates of speed, and to prevent such objects from passing by.

### FIELD OF THE INVENTIONS

The change in market-value for elite athletes presents an interesting set of parameters for developing athletes-in-training, those attempting to maintain fitness (as their own skills sets are constrained by other factors) and for anyone targeting para-optimal fitness levels and longevity. Likewise, mapping correlations between entertainment value and user compliance, especially in children, militates strongly for adoption of the instant teachings as progress in science and the useful arts.

Within in the athlete training arts systems exist which effectively cross boundaries between different sports. By way merely of example, the teachings of the present invention can readily be seen to apply to the sport of hockey for the purposes of the instant application, yet analogous activities in numerous sporting endeavors stand to benefit from the teachings of the present invention. Those skilled in the arts are fully cognizant that any hand-eye coordination and/or object tracking skills or muscle memory requiring aptitudes are beneficial according to the art of the instant teachings, as set forth herein and claimed below, as subject matter proprietary and eligible for United States Letters Patent.

Known as TRAINING BALLS, TRAINING AIDS, and to a certain extent, Dimpled Golf Balls, publications and patents such as US 2002/0121742, US 2007/0179021, US 2008/006435, US 2005/0239584, U.S. Pat. Nos. 4,830,378, 4,653,758, 4,542,902, 4,949,976, 7,641,572, 7,452,292, 4,830,378, each of which is expressly incorporated herein by reference as if fully set forth herein; have yet to disclose the instant teachings, yet each shows that one skilled in the art could understand and practice the objects of the present invention, in terms of balance, hand-eye coordination development and fitness.

### OBJECTS AND SUMMARIES OF THE INVENTIONS

Briefly stated, training methods for elite athletes feature spheroid training tools with increasing numbers of faceted surfaces to deflect in alinear, quasi-randomized fashion from a flat surface when impacting the same under force of a user's throws. Kits, spheroid training tools, and advanced exercise regimens are likewise taught, according to the present invention.

According to features, an enhanced process for training athletes is disclosed, the improvement comprising, in combination providing at least a spheroid training tool defined by a faceted rubber bouncing ball, instructing a user on usage of the same to mimick rapid movements of other objects to be caught, and, tracking progress in terms of duration, success and catching frequency.

According to features, new methodologies are disclosed along with apparatus, further comprising a plurality of spheroid training tools with increased numbers of facets per tool, designed to ramp in challenge level over time.

According to features, a training system is disclosed, further comprising an accompanying demonstration in at least one of audio and video format for correlating the exercises with a particular sport, instructions for use, and metrics for tracking progress, along with e-commerce and internet based modes for quasi-customizing the instant teachings.

### BRIEF DESCRIPTION OF THE FIGURES

FIGS. 1A through 1C schematically illustrate aspects of the positioning required for the glove hands of goalies, with angular changes, as addressed by the teachings of the present inventions;

FIGS. 2A through 2C likewise schematically illustrate an athlete using a spheroid teaching tool, showing related angular changes in an athlete practicing methods according to the instant teachings of the present inventions;

FIG. 3A shows an illustrative embodiment of a spheroid teaching tool, according to the instant teachings of the present inventions;

FIG. 3B shows an illustrative embodiment of a spheroid teaching tool, according to the instant teachings of the present inventions;

FIG. 3C shows an illustrative embodiment of a spheroid teaching tool, according to the instant teachings of the present inventions.

### DETAILED DESCRIPTION OF THE INVENTIONS

The present inventor has realized that by combining enhanced knowledge, experience and materials for training with improved spheroid training tools, athletes can be trained and conditioned to perform at elite levels in high-skill endeavors. Likewise, ease of use and incremental improvement drives methods to substantially improve user compliance according to the teachings of the present inventions.

The present inventor was spawned in the Soviet Union and played professional hockey before devoting his time to training other athletes. His first-hand knowledge has distinguished all of the teachings of the prior art from the instant innovations, it is respectfully proposed.

For the purposes of this application, “spheroid training tool” is defined as any solid rubber ball (for example, the Superball® brand of bouncing rubber ball available from Wham-O® of Woodland Hills, Calif., 91367), having a diameter of between at least about 1^{11/16}″ and 3″ wherein at least one aspect of peripheral surface area has been removed to define a flattened surface element.

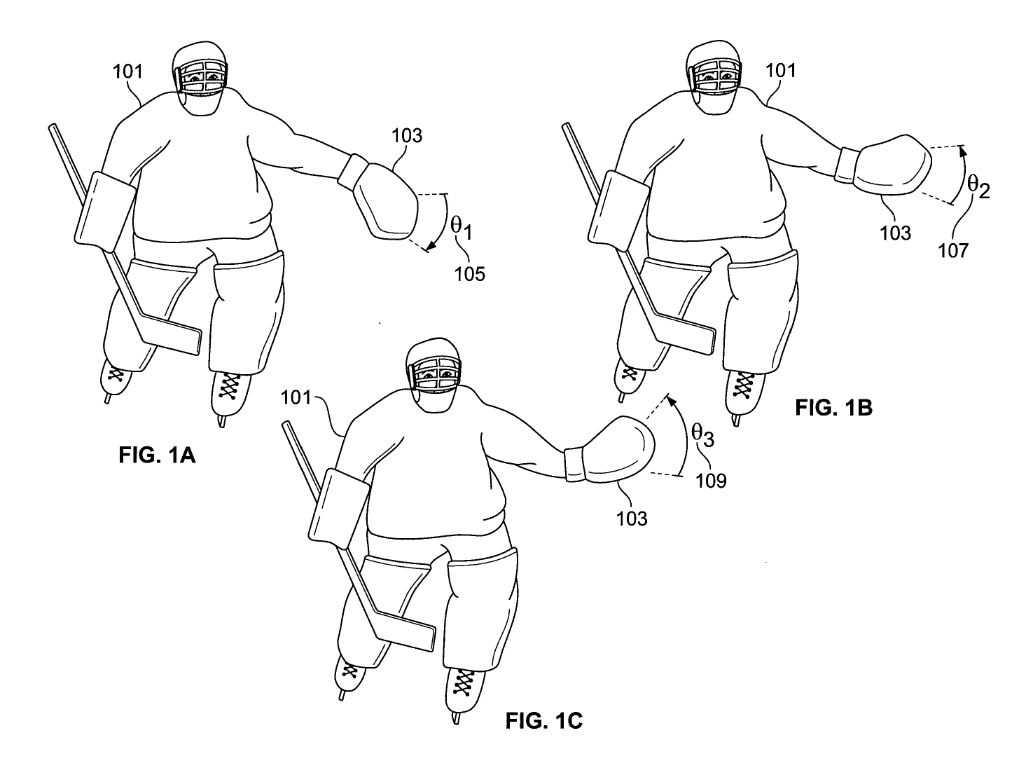

Referring now to FIGS. 1A, 1B, and 1C, a schematicized athlete 101 (in this case, an ice hockey goalie) and relative positioning of a glove-member 103 are shown. Angle theta evolves from position 105, to position 107 and 109 to attempt to catch pucks and prevent them from passing behind the plane defined by the goal area and crease just behind the goalie (not shown). Artisans appreciate and understand that in hockey, players use sticks, other players, and any available surfaces to forcefully project pucks, balls, and related objects past goalies at high speeds.

Those skilled in the art will readily understand that glove-member 103 moves constantly from one position to another, and focus and balance must be maintained for periods of time intensely enough to catch or block more than 90% of shots taken by a “shooter” or player using a stick to forcefully direct a small flattened section of a cylinder (or hockey puck, in this example) at speeds which may exceed at least about 90 mph in some cases. Other sporting endeavors require similar movements, as known to those skilled in the art.

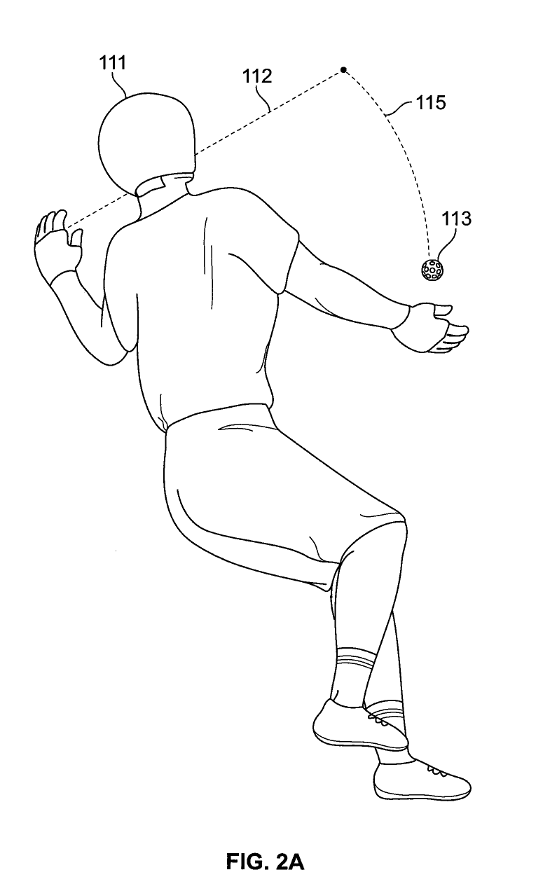

FIGS. 2A, 2B, and 2C likewise show athlete 111 in the process of throwing and catching spheroid training tool 113, as it travels first from a hand of user over linear trajectory 112 and then in a non-linear, quasi-randomized fashion along trajectory 115 after impacting a substantially planar surface at the “black dot” (not shown), such as a wall. The black dot illustrates a point of impact, while the respective dashed lines show a linear travel path 112 to a wall, and a quasi-randomized, alinear return path 115, 117, and 118. Artisans understand the relation between FIGS. 1A through 1C and 2A through 2C, and the further description is omitted at this time. When an athlete can self-train and develop skills related to those which are required for competition, the additional benefit of user compliance rises.

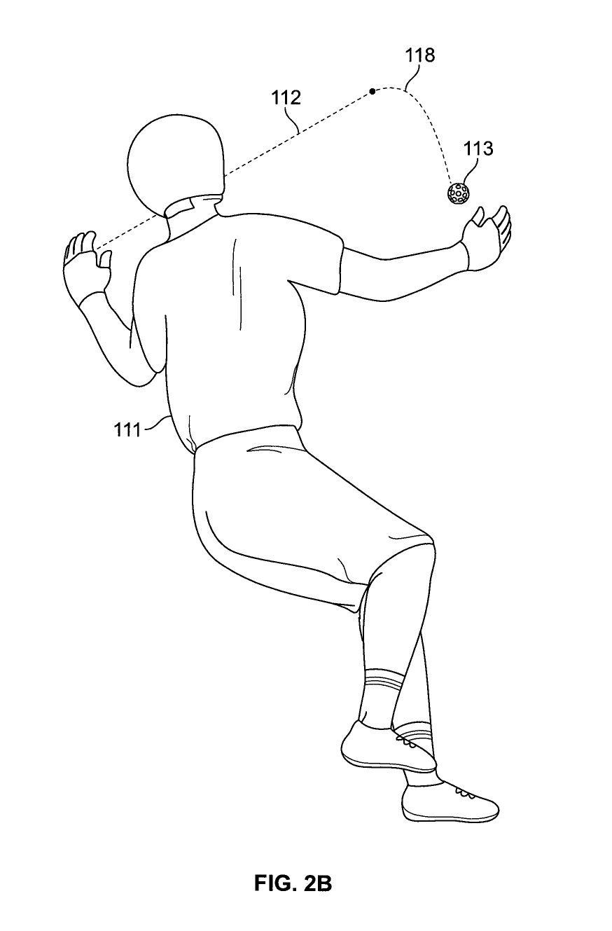

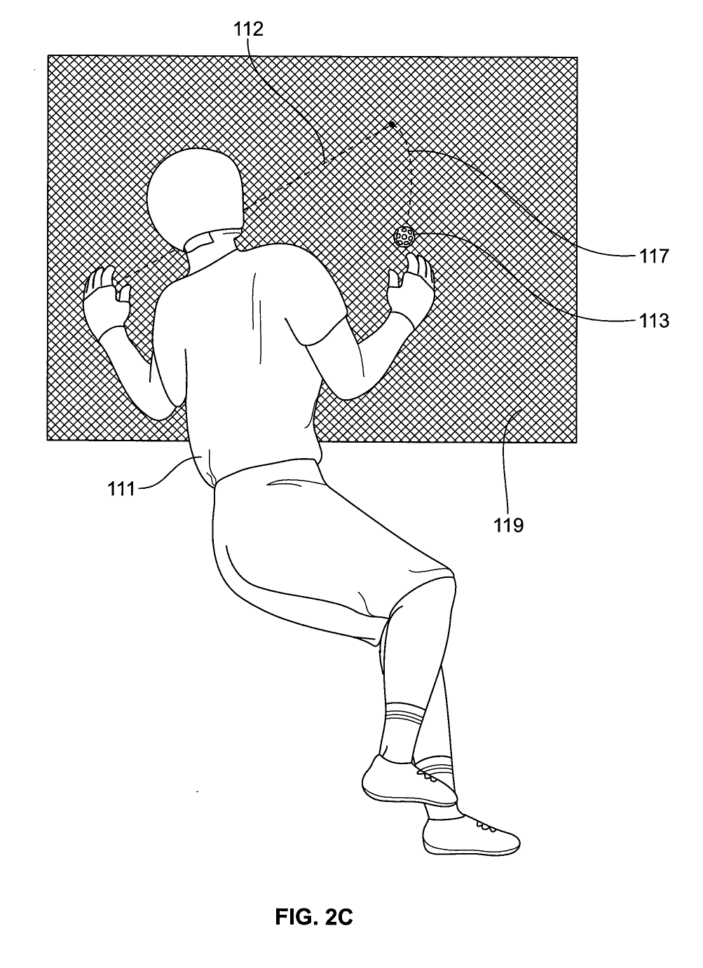

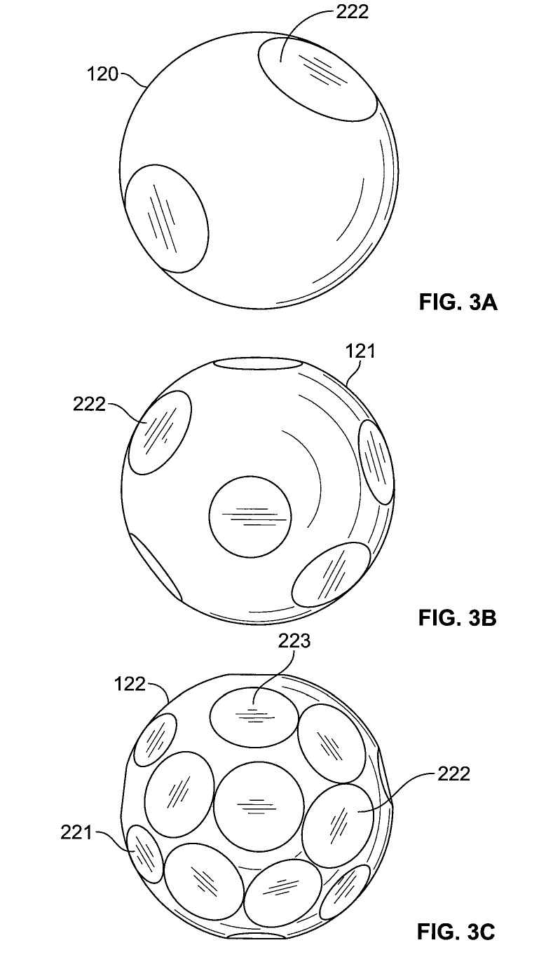

Among novel features of the instant teachings, referring still to FIGS. 2A, 2B, and 2C are faceted surfaces 221, 222, and 223 of spheroid training tool 113 (in FIGS. 2A, 2B, and 2C) 120, 121, 122 (in FIGS. 3A, 3B, and 3C) which cause quasi-randomized, alinear return paths 115, 117, and 118, when impacting wall—or mat 119 which may be used for making a less than planar fortified surface amenable to usage with the present invention.

Sill referring to FIG. 3A, spheroid training tool 120 according to embodiments has at least about three illustrative shapes 120, 121, 122 with varying degrees of faceting. The more facets 221, 222, 223, the more quasi-randomized the trajectory back from walls.

Alternate approaches to “randomizing” the travel paths of balls have included extensions, projections, and removable pieces. The present invention is distinguished from each of these because they often fail mechanically, or are too random to be useful with the context of the present inventions. See, for example, BUMPLE BALLS™ available from Hedstrom Specialty.

According to aspects of the instant methods, those in training progress from spheroid training tool 120 to 121 and 122, each with increasing degrees of difficulty. Again, with younger athletes or those needing ongoing positive reinforcements using more easily caught spheroid training tools enhanced user compliance in studies that have been made to date (GGA Goalie Academy, Van Nuys, Calif. 91405).

While the method and apparatus have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. In an enhanced process for training athletes, the improvement comprising, in combination:
providing at least a spheroid training tool defined by a faceted rubber bouncing ball;
instructing a user on usage of the same to mimick rapid movements of other objects to be caught; and,
tracking progress in terms of duration, success and catching frequency.

2. The enhanced process of claim 1, further comprising: at least two spheroid training tools with different numbers of facets per tool.

3. The enhanced process of claim 1, further comprising: a plurality of spheroid training tools with increased numbers of facets per tool.

4. The enhanced process of claim 1, further comprising at least a mat surface to attach to a wall creating a flattened grid.

5. The enhanced process of claim 2, further comprising at least a mat surface to attach to a wall creating a flattened grid.

6. The enhanced process of claim 3, further comprising at least a mat surface to attach to a wall creating a flattened grid.

7. A training system for goalies, which comprises, in combination:
at least two spheroid training tools, and,
a series of tiered exercises for bouncing spheroid training tools to simulate action during competition.

8. The training system of claim 7, further comprising an accompanying demonstration in at least one of audio and video format for correlating the exercises with a particular sport.

9. The training system of claim 7, wherein said sport is hockey.

10. The training system of claim 7, wherein said sport is ice hockey.

11. The training system of claim 7, wherein said sport is roller hockey.

12. The training system of claim 7, said sport being at least one goalkeeper involving sport selected from the group of lacrosse, field hockey, soccer and European hand ball.

13. Spheroid training tools, which comprise, in combination:
a base solid rubber bouncing ball;
wherein at least one aspect of peripheral surface area has been removed to define a flattened or faceted region.

14. Spheroid training tools, according to claim 13, wherein greater than two aspects of peripheral surface area have been removed to define flattened or faceted regions.

15. Spheroid training tools, according to claim 13, wherein a plurality of aspects of peripheral surface area have been removed to define flattened or faceted regions.

16. A kit, comprising, in combination, at least one spheroid training tool, and instructions for use.

17. The kit of claim 16, further comprising internet-based information and data, linked by customer permissions.

18. The kit of claim 16, wherein the instructions for use include methods of making quasi-customized spheroid training tools.

19. The kit of claim 17, wherein the instructions for use include methods of making quasi-customized spheroid training tools.

20. The kit of claim 19, further comprising ornamental and team branding-based decals, stickers and accoutrements for creating at least one of team, brand, club, or corporate loyalty.
